(19) United States
(12) Patent Application Publication
(10) Pub. No.: US 2006/0111410 A1
(43) Pub. Date: May 25, 2006

(54) Microbicide substances

(76) Inventors: Peter Wachtler, Krefeld (DE); Martin Kugler, Leichlingen (DE)

Correspondence Address: Lanxess Corporation;Law & Intellectual Property Department, 111 Ride Park West Drive, Pittsburgh, PA, 15275-1112, US

(21) Appl. No.: 10/533,977

(22) PCT Filed: Oct. 25, 2003
(86) PCT No.: PCT/EP03/11884

§ 371 Date: Dec. 2, 2005

(30) Foreign Application Priority Data
Nov. 8, 2002 (DE) 102 51 915.3

(51) Int. Cl. A01N 43/80; A01N 47/28; C09D 5/16

(52) U.S. Cl. 514/373; 514/594; 523/122

(57) ABSTRACT

The invention relates to antimicrobial, synergistically active mixtures of 1,2-benzisothiazolinone (BIT) and tetramethylolacetylenediurea (TMAD).

The present application provides novel mixtures comprising 1,2-benzisothiazolinone (BIT) and tetramethylolacetylenediurea (TMAD), processes for their preparation and their use for protecting industrial materials and products against attack and destruction by microorganisms, and also microbicidal compositions based on these novel mixtures.

1,2-Benzisothiazolinone (BIT) and its sodium, potassium or lithium salts are active compounds which have been used in practice for a long time to prepare microbicidally active formulations. 1,2-Benzisothiazolinone (BIT) is distinguished by good chemical and thermal stability and, in principle, has a broad antimicrobial action (bacteria, fungi, yeasts). However, the efficacy against certain species of bacteria is not always satisfactory, and the observed speed of action is in some cases insufficient to avoid microbially induced damage to materials.

Tetramethylolacetylenediurea (TMAD) is a known biocidally active compound based on a formaldehyde-releasing compound and has already been used for multifarious applications in industrial preservation (adhesives, paints, concrete additives, etc.). Tetramethylolacetylenediurea (TMAD) has favorable properties typical for a formaldehyde-releasing compound, such as, for example, good bactericidal activity, rapid onset of action and activity in the gas phase. However, owing to the limited activity spectrum of formaldehyde-releasing compounds (mainly against bacteria), in practice, to obtain satisfactory results, the application rates required in some cases merit improvement with respect to safe and economical use.

Surprisingly, we have now found novel mixtures based on 1,2-benzisothiazolinone (BIT) and its sodium, potassium or lithium salt and tetramethylolacetylenediurea (TMAD) which overcome the disadvantages of the respective individual components in an advantageous manner and thus contribute to improving the prior art.

Accordingly, the present invention relates to mixtures which are characterized in that they comprise 1,2-benzisothiazolinone (BIT) and/or its sodium, potassium or lithium salts and tetramethylolacetylenediurea (TMAD) as active components.

The mixtures according to the invention are highly active against microorganisms and can be used for protecting industrial materials against attack and destruction by microorganisms.

In addition, surprisingly, the mixtures according to the invention are distinguished in that, in specific mixing ratios, they have an unexpectedly high, synergistic enhancement of activity. As a consequence, the concentrations required of the mixtures according to the invention for protecting industrial materials can be reduced compared to the concentrations required of the respective individual compounds. This is extremely advantageous from an economical, ecological and technical point of view and contributes to increasing the preservation quality.

The active compound mixtures according to the invention are preferably used to preserve functional fluids and aqueous industrial products susceptible to attack by microorganisms.

The following industrial materials and products may be mentioned by way of example, but not by way of limitation, as possible applications of the active compound mixtures according to the invention:
paints, colors, plasters and other coating materials
starch solutions or slurries or other starch-based products, such as, for example, printing thickeners or starch glues
slurries of other raw materials, such as color pigments (for example iron oxide pigments, carbon black pigments, titanium dioxide pigments) or slurries of fillers and coating pigments, such as kaolin, calcium carbonate or talc
chemical products for the building industry, such as concrete additives based, for example, on molasses, lignosulfonates or polyacrylates, bitumen emulsions or sealants
glues and adhesives based on known raw materials of animal, vegetable or synthetic origin
polymer dispersions based, for example, on polyacrylate, polystyrene acrylate, styrenebutadiene, polyvinyl acetate, inter alia
detergents and cleaners for industrial and domestic use
mineral oils or mineral oil products (such as, for example, diesel fuels)
cooling lubricants for metal processing based on mineral oil-containing, semisynthetic or synthetic concentrates
auxiliaries for the leather, textile or photochemical industry
precursors and intermediates of the chemical industry, for example in the production and storage of dyestuffs
solvent-borne or water-borne inks
wax and clay emulsions.

The mixtures according to the invention may additionally comprise one or more further biocidally active compounds. The compounds
benzyl hemiformal
bronopol
chloromethylisothiazolinone
p-chloro-m-cresol
dimethylolurea
4,5-dichloro-2-n-octylisothiazolin-3-one
1,2-dibromo-2,4-dicyanobutane
2,2-dibromo-3-nitrilopropionamide
ethylene glycol hemiformal
ethylene glycol bishemiformal
glutaraldehyde
iodopropargyl butylcarbamate
methylisothiazolinone
N-methylolurea
2-n-octylisothiazolin-3-one
2-phenoxyethanol
phenoxypropanol
o-phenylphenol
quaternary ammonium salts, such as, for example, N-alkyl-N,N-dimethylbenzyl-ammonium chloride
trimethylene-2-methylisothiazolin-3-one
   and, if appropriate, further compounds may be mentioned as co-components.

The amounts of 1,2-benzisothiazolinone (BIT) and/or its sodium, potassium or lithium salts and tetramethylolacetylenediurea (TMAD) in the mixtures according to the invention may be varied within a wide range. In mixtures with broad antimicrobial action which serve to protect functional fluids and aqueous industrial products, the ratio of 1,2-benzisothiazolinone (BIT) to tetramethylolacetylenediurea (TMAD) is generally a weight ratio of from 9:1 to 1:9, preferably from 5:1 to 1:5, particularly preferably from 1:1 to 1:5.

In the protection of materials, the mixtures according to the invention can be used for protecting industrial materials, in particular for protecting aqueous functional fluids; they are effective against bacteria, molds, yeasts and also against slime organisms. The following microorganisms may be mentioned by way of example, but not by way of limitation:

Alternaria, such as Alternaria tenius, Aspergillus, such as Aspergillus niger, Chaetomium, such as Chaetomium globosum, Fusarium, such as Fusarium solani, Lentinus, such as Lentinus tigrinus, Penicillium, such as Penicillium glaucum; Alcaligenes, such as Alcaligenes faecalis, Bacillus, such as Bacillus subtilis, Escherichia, such as Escherichia coli, Pseudomonas, such as Pseudomonas aeruginosa or Pseudomonas fluorescens, Staphylococcus, such as Staphylococcus aureus;

Candida, such as Candida albicans, Geotrichum, such as Geotrichum candidum, Rhodotorula, such as Rhodotorula rubra.

The mixtures according to the invention can be prepared by mixing the individual components, if appropriate with addition of one or more solvents and if appropriate further antimicrobially active compounds.

Depending on their respective physical and/or chemical properties, the mixtures according to the invention can be applied either separately in the form of a metered addition of the individual active compounds, where the concentration ratio may be individually adjusted depending on the preservation problem present, or the finished mixture may be metered in. Here, it is also possible to convert the mixture according to the invention beforehand into a customary formulation, such as, for example, solutions, emulsions, suspensions, powders, foams, pastes, granules, aerosols and microencapsulations in polymeric substances.

These formulations are prepared in a manner known per se, for example by mixing the mixture according to the invention or the individual active compounds comprised therein with extenders, i.e. liquid solvents, pressurized liquefied gases and/or solid carriers, if appropriate with the use of surfactants, i.e. emulsifiers and/or dispersants and/or foam formers. If the extender used is water, it is also possible to use, for example, organic solvents as auxiliary solvents. Essentially, suitable liquid solvents include: alcohols, such as butanol or glycols, and also ethers and esters thereof, ketones, such as acetone, methyl ethyl ketone, methyl isobutyl ketone or cyclohexanone, strongly polar solvents, such as dimethylformamide or dimethyl sulfoxide, and also water; liquefied gaseous extenders or carriers are to be understood as meaning liquids which are gaseous at ambient temperature and under atmospheric pressure, for example aerosol propellants, such as halogenated hydrocarbons, and also butane, propane, nitrogen and carbon dioxide; suitable solid carriers are: for example ground natural minerals, such as kaolins, clays, talc, chalk, quartz, attapulgite, montmorillonite or diatomaceous earth, and ground synthetic minerals, such as finely divided silica, aluminum oxide and silicates; suitable solid carriers for granules are: for example crushed and fractionated natural rocks, such as calcite, marble, pumice, sepiolite and dolomite, and also synthetic granules of inorganic and organic meals, and granules of organic material such as sawdust, coconut shells, corn cobs and tobacco stalks; suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulfonates, alkyl sulfates, arylsulfonates, and also protein hydrolysates; suitable dispersants are: for example lignosulfite waste liquors.

Tackifiers and thickeners such as carboxymethylcellulose and natural and synthetic polymers in the form of powders, granules or latices, such as gum arabic, polyvinyl alcohol, polyvinyl acetate, and also natural phospholipids, such as cephalins and lecithins and synthetic phospholipids can be used in the formulations. Other possible additives are mineral and vegetable oils.

The present invention furthermore provides microbicidal compositions based on the active compound mixtures according to the invention, which compositions comprise at least one solvent or diluent and also, if appropriate, processing auxiliaries and if appropriate further antimicrobially active compounds.

The microbicidal compositions or formulated concentrates to be used for protecting industrial materials comprise the active compounds 1,2-benzisothiazolinone (BIT) and/or its sodium, potassium or lithium salts and tetramethylolacetylenediurea (TMAD), calculated as the sum of both active compounds, in a concentration of from 5 to 80% by weight, preferably from 10 to 60% by weight.

The use concentrations of the active compound combinations to be used according to the invention depend on the nature and the occurrence of the microorganisms to be controlled, on the initial microbial load and on the composition of the material to be protected. Prior to use in practice, the optimum amount to be employed for a particular application can be determined in the laboratory by test series. In general, the use concentrations are in the range from 0.01 to 5% by weight, preferably from 0.05 to 1.0% by weight, of the mixture according to the invention, based on the material to be protected.

There are certain germs which are particularly relevant in practice, such as, for example, Pseudomonas fluorescens or Pseudomonas aeruginoa (see Examples 1 and 2), where the mixtures according to the invention are notable for synergistic effects, i.e. the activity of the mixture is greater than the activity of the individual components.

The observed synergism of the mixtures according to the invention can be determined by the following mathematical approach (cf. F. C. Kull, P. C. Elisman, H. D. Sylwestrowicz and P. K. Mayer, Appl. Microbiol. 9, 538 (1961):

$$synergistic index ( SI ) = \frac{{Q}_{a}}{{Q}_{A}} + \frac{{Q}_{b}}{{Q}_{B}}$$

where
Qₐ=the amount of component A in the active compound mixture required to achieve the desired effect, i.e. no microbial growth,
Q_{A}=the amount of component A which, applied on its own, suppresses the growth of the microorganisms,
Q_{b}=the amount of component B in the active compound mixture which supresses the growth of the microorganisms, and
Q_{B}=the amount of component B which, applied on its own, suppresses the growth of the microorganisms.

A synergistic index of SI<1 indicates a synergistic effect for the active compound mixture.

Using the calculations below, the synergistic activity enhancement is documented by way of example, but not by way of limitation.

### EXAMPLES

### Example 1

Synergism BIT/MAD

Test germ: Pseudomonas fluorescens

The numbers in brackets indicate the weight ratio of the active compounds in the mixtures.

$$synergistic index ( SI ) = \frac{{Q}_{a}}{{Q}_{A}} + \frac{{Q}_{b}}{{Q}_{B}}$$

A=BIT/B=TMAD

| | |
|---|---|
| Pseudomonas fluorescens | SI |

Amounts of the pure active compounds required
to suppress growth (ppm)

| | |
|---|---|
| BIT | 20 |
| TMAD | 500 |

Amounts in the active compound mixtures required
to suppress growth (ppm)

| | | |
|---|---|---|
| BIT/TMAD (9:1) | 4.5/1 | 0.23 |
| BIT/TMAD (8:2) | 4/2 | 0.2 |
| BIT/TMAD (7:3) | 3.5/1 | 0.2 |
| BIT/TMAD (6:4) | 4.5/3 | 0.32 |
| BIT/TMAD (5:5) | 5/10 | 0.27 |
| BIT/TMAD (4:6) | 4/12 | 0.32 |
| BIT/TMAD (3:7) | 6/14 | 0.33 |
| BIT/TMAD (2:8) | 4/16 | 0.23 |
| BIT/TMAD (1:9) | 5/90 | 0.43 |

The combinations according to the invention have pronounced synergistic action.

### Example 2

Synergism BIT/TMAD

Test germ: Pseudomonas aeruginosa

The numbers in brackets indicate the weight ratio of the active compounds in the mixtures.

$$synergistic index ( SI ) = \frac{{Q}_{a}}{{Q}_{A}} + \frac{{Q}_{b}}{{Q}_{B}}$$

A=BIT/B=TMAD

| | |
|---|---|
| Pseudomonas fluorescens | SI |

Amounts of the pure active compounds required
to suppress growth (ppm)

| | |
|---|---|
| BIT | 20 |
| TMAD | 500 |

Amounts in the active compound mixtures required
to suppress growth (ppm)

| | | |
|---|---|---|
| BIT/TMAD (9:1) | 4.5/1 | 0.23 |
| BIT/TMAD (8:2) | 4/2 | 0.2 |
| BIT/TMAD (7:3) | 3.5/3 | 0.18 |
| BIT/TMAD (6:4) | 4.5/6 | 0.24 |
| BIT/TMAD (5:5) | 5/10 | 0.27 |
| BIT/TMAD (4:6) | 4/12 | 0.32 |
| BIT/TMAD (3:7) | 3/14 | 0.18 |
| BIT/TMAD (2:8) | 4/16 | 0.23 |
| BIT/TMAD (1:9) | 5/90 | 0.43 |

The combinations according to the invention have pronounced synergistic action.

1. A mixture of biocidally active compounds, characterized in that it comprises tetramethylolacetylenediurea (TMAD) and 1,2-benzisothiazolinone (BIT) and/or its sodium, potassium or lithium salt.

2. The mixture as claimed in claim 1, characterized in that the weight ratio of 1,2-benzisothiazolinone (BIT) and/or its sodium, potassium or lithium salt to tetramethylolacetylenediurea (TMAD) is from 9:1 to 1:9.

3. A microbiocidal composition, comprising an active compound mixture as claimed in at least one of claims 1 and 2 and at least one auxiliary from the group of the solvents or solvent mixtures, extenders, surfactants and, if appropriate, further antimicrobially active compounds.

4. The use of a mixture as claimed in at least one of claims 1 and 2 for protecting industrial materials against attack and/or destruction by microorganisms.

5. The use as claimed in claim 4, characterized in that the industrial materials are aqueous industrial products and aqueous functional fluids.

6. A method for protecting industrial materials against attack and/or destruction by microorganisms, characterized in that the industrial materials are treated or admixed with the mixture as claimed in at least one of claims 1 and 2.

7. A process for preparing a mixture as claimed in at least one of claims 1 and 2, characterized in that the individual components are mixed, if appropriate with addition of solvents or solvent mixtures, extenders, surfactants and further antimicrobially active compounds.

8. An industrial material, comprising an active compound mixture as claimed in at least one of claims 1 and 2.
